(19) United States
(12) Patent Application Publication
(10) Pub. No.: US 2010/0149105 A1
(43) Pub. Date: Jun. 17, 2010

(54) PORTABLE ELECTRONIC DEVICE

(75) Inventors: XIN-QUAN ZHOU, Shenzhen City (CN); HSIAO-HUA TU, Shindian (TW); YE LIU, Shenzhen City (CN); WEN-WEI SONG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/542,815

(22) Filed: Aug. 18, 2009

(30) Foreign Application Priority Data
Dec. 17, 2008 (CN) 200810306322.3

(51) Int. Cl. G06F 3/02

(52) U.S. Cl. 345/169

(57) ABSTRACT

A portable electronic device comprises a main enclosure, a QWERTY keyboard assembly, and a holder. The QWERTY keyboard assembly includes a plurality of keys disposed as a qwerty board. The holder includes a positioning portion, a connecting portion, and a receiving portion. The receiving portion is rotatably connected with the positioning portion via the connecting portion. The QWERTY keyboard assembly is received in the receiving portion, the positioning portion is secured to the main enclosure.

### BACKGROUND

1. Technical Field

The present disclosure relates to portable electronic devices and, particularly, to a portable electronic device with a smart keyboard.

2. Description of Related Art

A typical compact keypad adopted in a portable electronic device includes a plurality of input keys, the input keys may have multi-functions.

However, such type of keypad has a low input efficiency because advanced functions offered by a full scale keyboard are unavailable in the compact keypad for use in, e.g., games and text editing.

Therefore, there is room for improvement within the art.

### BRIEF DESCRIPTION OF THE DRAWINGS

Many aspects of a portable electronic device can be better understood with reference to the following drawings. These drawings are not necessarily drawn to scale, the emphasis instead being placed upon clearly illustrating the principles of the portable electronic device. Moreover, in the drawings like reference numerals designate corresponding sections throughout the several views.

FIG. 1 is an isometric, exploded view of a portable electronic device, in accordance with an exemplary embodiment.

FIG. 2 is similar to FIG. 1, but viewed from another aspect.

FIG. 3 is a partially assembled view of a portable electronic device shown in FIG. 1.

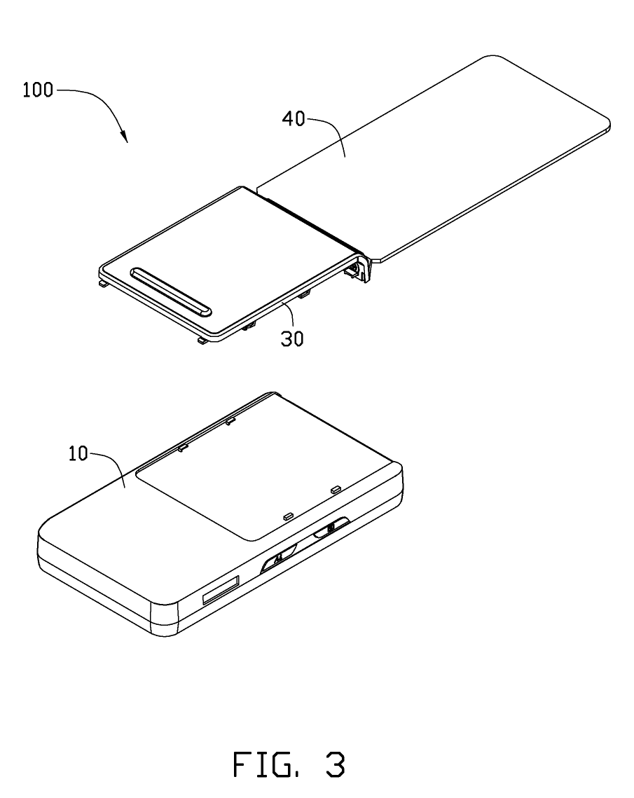

FIG. 4 is an assembled view of a portable electronic device shown in FIG. 1.

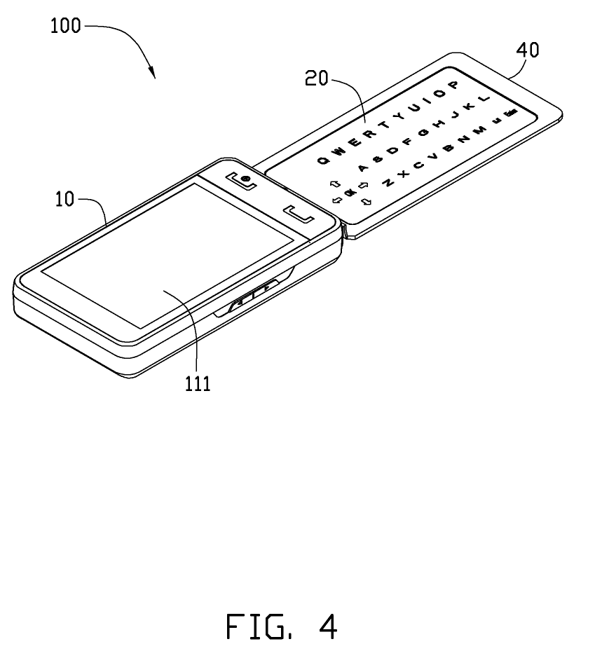

### DETAILED DESCRIPTION

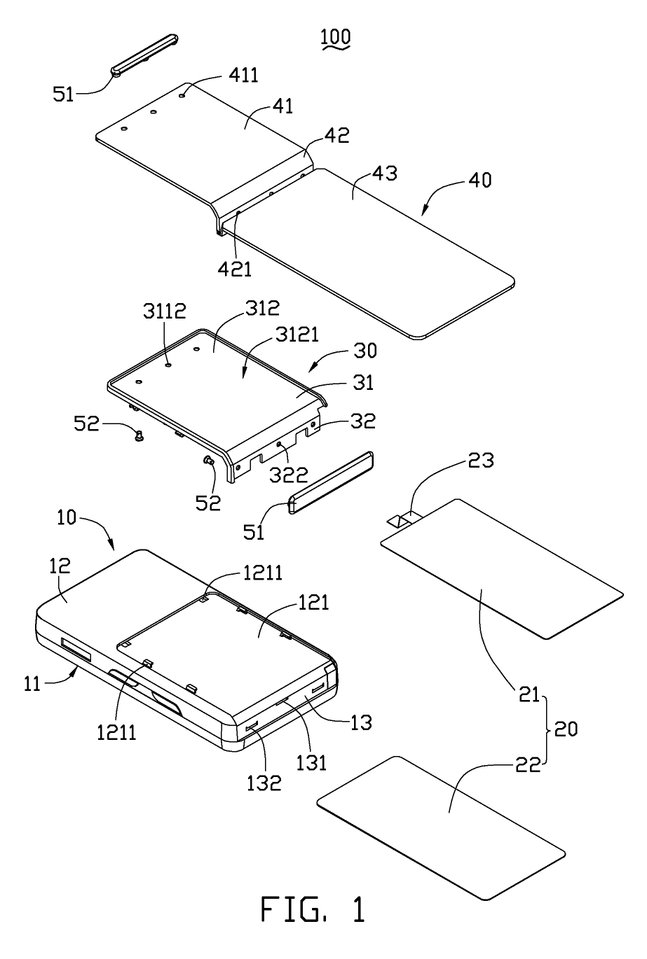

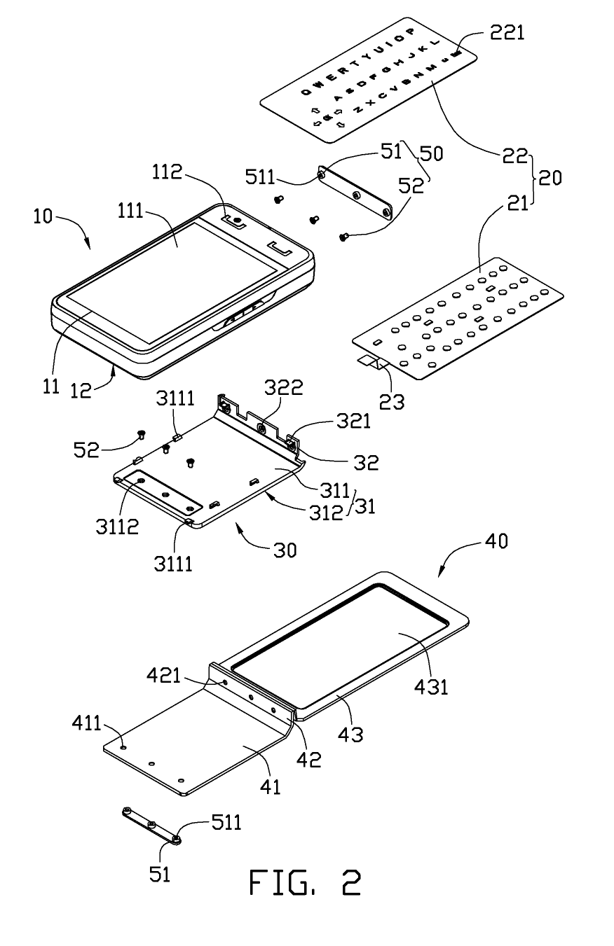

FIGS. 1 and 2 show an exemplary portable electronic device 100. The portable electronic device 100 includes a main enclosure 10, a compact QWERTY keyboard assembly 20, a cover member 30, a holder 40, and two fastening assemblies 50. The cover member 30 is mounted to the main enclosure 10. The QWERTY keyboard assembly 20 is mounted on the holder 40. The holder 40 is secured to the cover member 30 via the two fastening assemblies 50.

The main enclosure 10 is a housing of the portable electronic device 100, and includes a first wall 11, a second wall 12, and an end wall 13. The second wall 12 is opposite to the first wall 11. The end wall 13 connects the first wall 11 and the second wall 12. The main enclosure 10 further includes a display screen 111 and a plurality of buttons 112 disposed on the first wall 11. The main enclosure 10 further defines a receiving cavity 121 in the second wall 12. The receiving cavity 121 partially receives the cover member 30. The first wall 11 defines a plurality of latch holes 1211 around the receiving cavity 121. The cover member 30 is fastened to the main enclosure 10 via the latch holes 1211. The end wall 13 defines a through hole 131. The through hole 131 is used to receive connecting cables, thus electrically connecting the QWERTY keyboard assembly 20 to the main enclosure 10. The end wall 13 further defines two clamp holes 132 at opposite sides of the through hole 131.

The QWERTY keyboard assembly 20 includes a printed circuit board (PCB) 21, a keypad plate 22, and a connector 23. The keypad plate 22 is substantially a thin sheet. The keypad plate 22 is attached to the printed circuit board 21 such that signals can be inputted via the keypad plate 22. One end of the connector 23 is electrically connected to the PCB 21, the other is electrically connected to the main enclosure 10 through the through hole 131. In this embodiment, the connector 23 may be a bent resilient sheet.

The cover member 30 can be a battery cover of the portable electronic device 100. The cover member 30 includes a base sheet 31 and a side sheet 32. The side sheet 32 is connected to the base sheet 31. The base sheet 31 includes an outer wall 311 and a inner wall 312 on another side of the base sheet 31 opposite to the outer wall 311. The base sheet 31 further includes a plurality of protrusions 3111 protruding from the outer wall 311, corresponding to the latch holes 1211. The protrusions 3111 are able to latch in the latch holes 1211. The base sheet 31 defines a plurality of first fastening holes 3112 away from the side sheet 32. The fastening holes 3112 are used to engage with one of the fastening assemblies 50. The inner wall 312 defines a receiving groove 3121. The receiving groove 3121 is used to partially receive the holder 40. The side sheet 32 includes two latching poles 321 protruding outwards. The two latching poles 321 face the base sheet 31, corresponding to the clamp holes 132. The latching poles 321 latch into the clamp holes 132 correspondingly. The side sheet 32 further defines a plurality of second fastening holes 322. The fastening holes 322 are used to engage with the other fastening assembly 50.

The holder 40 includes a positioning portion 41, a connecting portion 42, and a receiving portion 43. The connecting portion 42 connects the positioning portion 41 and the receiving portion 43, and the receiving portion 43 can rotate around the connecting portion 42, relative to the positioning portion 41. The connecting portion 42 may be a typical hinge (schematically shown). The connecting portion 42 defines three mounting holes 421, corresponding to the latching poles 321. The positioning portion 41 defines three securing holes 411, corresponding to the first fastening holes 3112. The receiving portion 43 defines an accommodating cavity 431, used to receive the QWERTY keyboard assembly 20.

The fastening assembly 50 includes three typical screws 51 and a fastening plate 52. The fastening plate 52 defines three screw holes 521. The fastening plate 52 are engageable by the screws 51 correspondingly. The fastening assembly 50 is used to mount the holder 40 to the cover member 30.

In assembly, the QWERTY keyboard assembly 20 is inserted into the accommodating cavity 431 of the receiving portion 43. The positioning portion 41 of the receiving portion 43 is inserted into the receiving groove 3121, then the positioning portion 41 and the connecting portion 42 are secured to the cover member 30 with the two fastening assemblies 50. The cover member 30 is latched to the main enclosure 10, with the latching poles 321 latched in the clamp holes 132 and the protrusions 3111 latched in the latch holes 1211 correspondingly. The QWERTY keyboard assembly 20 can be rotated about the connecting portion 42, thus folded over the display screen 111. To use the QWERTY keyboard assembly 20, the QWERTY keyboard assembly 20 is rotated about the connecting portion 42 until the QWERTY keyboard assembly 20 is parallel with the display screen 111. As a result, input signals can be inputted via the 20 simultaneously while viewing the display screen 111.

It is to be understood, the side sheet 32 and the corresponding fastening assembly 50 can be omitted.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A portable electronic device comprising:
a main enclosure;
a QWERTY keyboard assembly including a plurality of keys;
a holder including a positioning portion, a connecting portion, and a receiving portion, the receiving portion being rotatably connected with the positioning portion via the connecting portion, the QWERTY keyboard assembly being received in the receiving portion, the positioning portion being secured to the main enclosure.

2. The portable electronic device as claimed in claim 1, wherein the connecting portion is a hinge.

3. The portable electronic device as claimed in claim 1, wherein the receiving portion defines an accommodating cavity, used to receive the QWERTY keyboard assembly therein.

4. The portable electronic device as claimed in claim 1, wherein the main enclosure including a display screen, the QWERTY keyboard assembly is rotated about the connecting portion, covering the display screen.

5. The portable electronic device as claimed in claim 1, wherein the QWERTY keyboard assembly includes a printed circuit board, a keypad plate, and a connector, one end of the connector is electrically connected to the printed circuit board, the other is electrically connected to the main enclosure.

6. The portable electronic device as claimed in claim 5, wherein the connector is a bent elastic sheet.

7. The portable electronic device as claimed in claim 1 further comprising a cover member, wherein the cover member is mounted to the main enclosure, the holder is mounted to the cover member.

8. The portable electronic device as claimed in claim 7, wherein the cover member includes a base sheet and a side sheet, the side sheet is connected to the base sheet.

9. The portable electronic device as claimed in claim 8, wherein the base sheet includes a outer wall and a inner wall opposite to the outer wall, a plurality of protrusions protrude from the outer wall, the main enclosure defines a plurality of latch holes, the protrusions latch into the latch holes.

10. The portable electronic device as claimed in claim 9, wherein the inner wall defines a receiving groove, used to receive part of the holder therein.

11. The portable electronic device as claimed in claim 9, wherein two latching poles protruding from the side sheet, facing the base sheet, the main enclosure defines clamp holes, the latching poles latch into the clamp holes.

12. A portable electronic device comprising:
a main enclosure including a display screen;
a QWERTY keyboard assembly rotatably connected to the main enclosure, the QWERTY keyboard assembly being parallel with the display screen in use, while covering the display screen in no use.

13. The portable electronic device as claimed in claim 12, further comprising a holder, wherein the holder includes a positioning portion, a connecting portion, and a receiving portion, the connecting portion connecting the positioning portion and the receiving portion, and the receiving portion rotating relative to the positioning portion about the connecting portion, the QWERTY keyboard assembly being received in the receiving portion, the positioning portion being secured to the main enclosure.

14. The portable electronic device as claimed in claim 13, wherein the connecting portion is a hinge.

15. The portable electronic device as claimed in claim 13, wherein the receiving portion defines an accommodating cavity, used to receive the QWERTY keyboard assembly therein.

16. The portable electronic device as claimed in claim 13, wherein the QWERTY keyboard assembly includes a printed circuit board, a keypad plate, and a connector, one end of the connector is electrically connected to the printed circuit board, the other is electrically connected to the main enclosure.

17. The portable electronic device as claimed in claim 16, wherein the connector is a bent elastic sheet.

18. The portable electronic device as claimed in claim 14 further comprising a cover member, wherein the cover member is mounted to the main enclosure, the holder is mounted to the cover member.
